(19) United States
(12) Patent Application Publication
(10) Pub. No.: US 2015/0127642 A1
(43) Pub. Date: May 7, 2015

(54) ACTIVE CHRONICLE COMPARISON SYSTEM USING WEBSITES

(71) Applicant: Sang Dae HAN, Jongno-gu Seoul (KR)

(72) Inventor: Sang Dae Han, Seoul (KR)

(21) Appl. No.: 14/405,786

(22) PCT Filed: Apr. 25, 2013
(86) PCT No.: PCT/KR2013/003506

§ 371 Date: Dec. 5, 2014

(30) Foreign Application Priority Data
Jun. 11, 2012 (KR) 10-2012-0062337

(51) Int. Cl. G06F 17/30

(52) U.S. Cl. CPC G06F 17/30864; G06F 17/30598
USPC 707/725

(57) ABSTRACT

An active chronicle comparison system using websites, including: a database unit for arranging and storing occurrence dates and contents of events that occurred for respective topics into the DB; an engine unit for operating in conjunction with the DB unit, and generating chronological table data using the contents and the occurrence dates of the events in the DB unit, upon receiving a request for inquiry of events; and a user terminal for operating in conjunction with the engine unit, and displaying the chronological table data generated by the engine unit.

### CROSS REFERENCE TO PRIOR APPLICATIONS

This application is a National Stage Application of PCT International Patent Application No. PCT/KR2013/003506 filed on Apr. 25, 2013, under 35 U.S.C. §371, which claims priority to Korean Patent Application No. 10-2012-0062337 filed on Jun. 11 2012, which are all hereby incorporated by reference in their entirety.

### BACKGROUND

The present invention relates, in general, to an active chronicle comparison system using websites and, more particularly, to an active chronicle comparison system using websites, which comparatively displays multiple chronological tables on a single screen when showing events that occurred for respective topics and the occurrence times (dates) of the events in the form of chronological tables, and which allows a service user to actively change the unit of a comparing period sector.

Generally, the term “chronological table” denotes a table into which past events that occurred for a specific topic, such as history, are obviously arranged for respective times (dates).

As a prior document which utilizes such a chronological table, U.S. Patent Application Publication No. US2008/0177693 discloses a digital chronology proving apparatus in which a personal life or a topic of interest is input to a chronological table, and a relevant chronological table is displayed via a terminal.

Referring to the above prior document, there are provided advantages in that details that are individually input for personal histories or topics of interest (e.g., TV animation, comics, movie, toy, etc.) may be displayed in the order of date, and two or more input topics may be inquired and compared with each other for each year.

However, the prior document is problematic in that, in order to compare two topics with each other, a target chronological table to be compared must be selected in advance upon constructing a chronological table, and the range (unit) of a period (time axis) that is a basis of the chronological table cannot be set to a period other than year.

### SUMMARY OF THE INVENTION

The present invention is devised to meet the above and other necessities.

An object of the present invention is to provide an active chronicle comparison system using websites, which constructs a database (DB) by arranging events for various topics and the occurrence dates thereof into chronological tables, and which displays individual chronological tables on a single screen so that each chronological table can be compared with other chronological tables, thus enabling histories in different fields to be simply compared with each other.

Another object of the present invention is to provide a user-customizable chronological table by restructuring events for respective topics in units of a comparing period sector selected by a user, such as 1 year, 10 years, 100 years, or 1000 years, upon comparing two or more types of chronological tables with each other.

In order to accomplish the above objects, the present invention provides an active chronicle comparison system using websites, including a database (DB) unit for arranging and storing occurrence dates and contents of events that occurred for respective topics into a DB; an engine unit for operating in conjunction with the DB unit, and generating chronological table data using the contents and the occurrence dates of the events in the DB unit, upon receiving a request for inquiry of events; and a user terminal for operating in conjunction with the engine unit, and displaying the chronological table data generated by the engine unit, wherein the engine unit is configured to, when a request for inquiry about events for two or more topics is received from the user terminal, restructure pieces of chronological table data matching the requested two or more topics in units of a comparing period sector selected by the user to generate one comparative chronological table (comparing time table), and display the comparative chronological table on the user terminal.

The present invention constructs a DB by arranging history into chronological tables, and displays the chronological tables on a single screen so that individual chronological tables can be compared with each other, thus obtaining the advantage of easily comparing histories matching different fields and topics.

Further, the present invention is advantageous in that, upon comparing chronological tables matching different topics, events included in each chronological table are restructured depending on the unit of the comparing period sector set by a user, such as 10 years, 100 years, or 1000 years, and the restructured events are displayed on the screen as a new chronological table. This function is advantageous in that a history for each topic can be edited according to user necessity, thus maximizing the utilization of chronological tables as comparative data and editing data.

Furthermore, the present invention may compare topics and events in all fields that can be arranged according to date, such as people, philosophy, art, learning, technology, sports, products, and company history, as well as history, with topics in different fields via various combinations.

Furthermore, the present invention is advantageous in that a unique URL address to a comparative screen completed by the user is generated and is transferred to the user terminal, thus enabling combinations of chronological table data to be very conveniently transferred to other users.

### BRIEF DESCRIPTION OF THE DRAWINGS

FIG. 1 is a block diagram showing an active chronicle comparison system using websites according to an embodiment of the present invention;

FIG. 2 is a flowchart showing the operation sequence of the active chronicle comparison system using websites, shown in FIG. 1;

FIG. 3 is a diagram showing a screen in which the elements of principal fields of a topic table used to construct a DB and an event table for storing events for respective topics, and in which sample data is input and illustrated;

FIG. 4 is a diagram showing an image of a state in which ‘United States (US) history’ is selected from the topic table and records having US history IDs are read from the event table and are displayed on the screen;

FIG. 5 is a diagram showing an image of a state in which chronological table data corresponding to ‘French history’ is added to the screen shown in FIG. 4;

FIG. 6 is a diagram showing an image of a state in which chronological table data corresponding to ‘Korean History’ is added to the screen shown in FIG. 5;

FIG. 7 is a diagram showing a screen in which a field is changed, and the life and history topics of personalities named ‘Bill Gates’ and ‘Steve Jobs’ are compared with each other and in which chronological table data corresponding to the topics is displayed;

FIG. 8 is a diagram showing an image of a state in which the unit of comparing period sector of the chronological table data in the screen shown in FIG. 7 is set to 10 years; and

FIG. 9 is a diagram showing an image of a state in which the comparing period sector of the chronological table data in the screen shown in FIG. 7 is set to 100 years.

### DETAILED DESCRIPTION

Hereinafter, embodiments of the present invention will be described in detail with reference to the attached drawings.

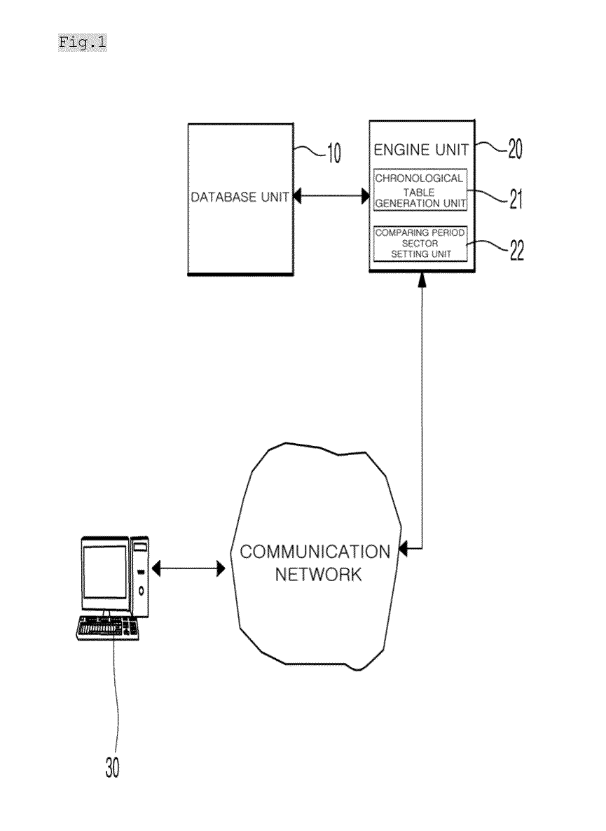

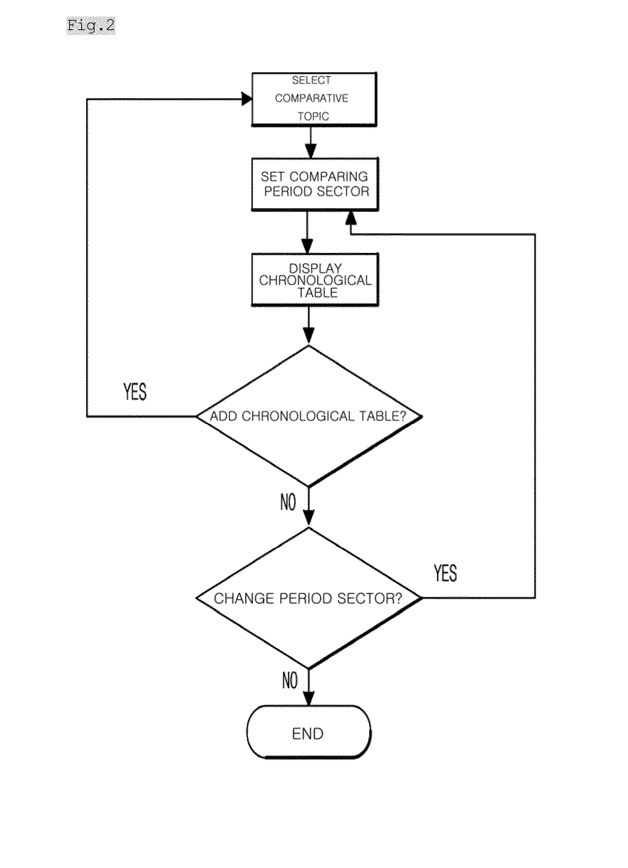

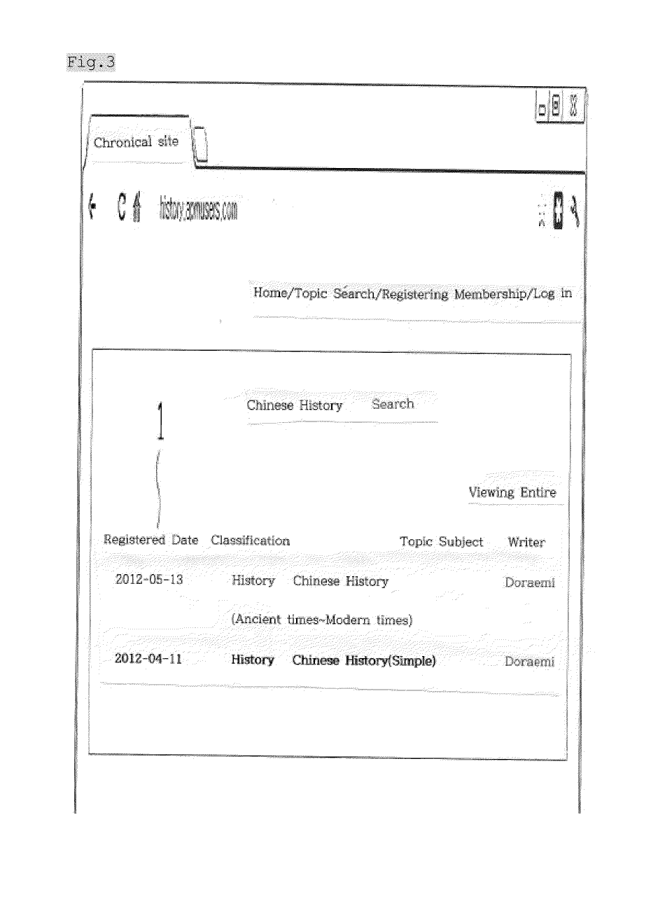

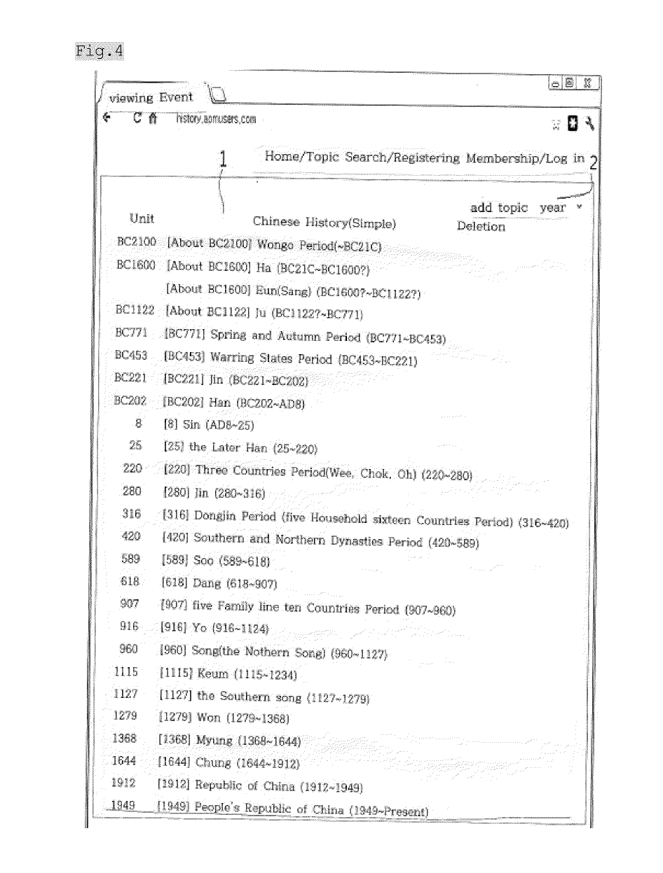

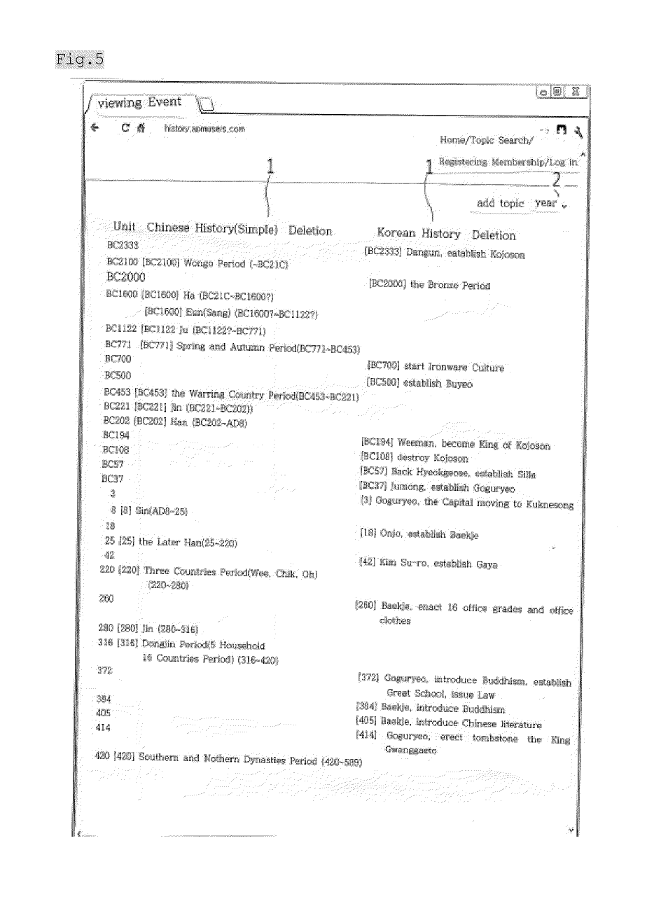

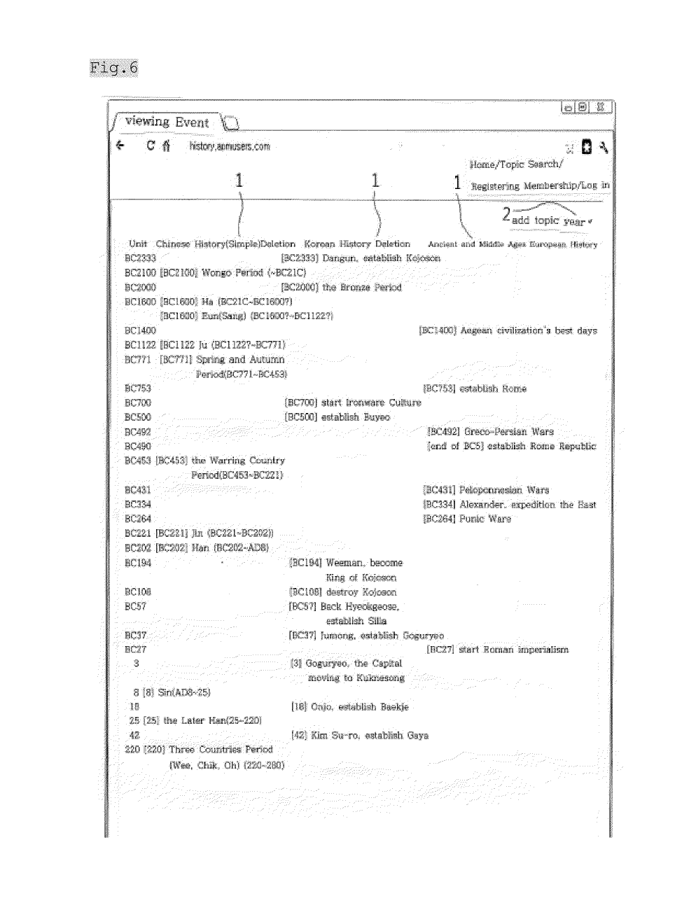

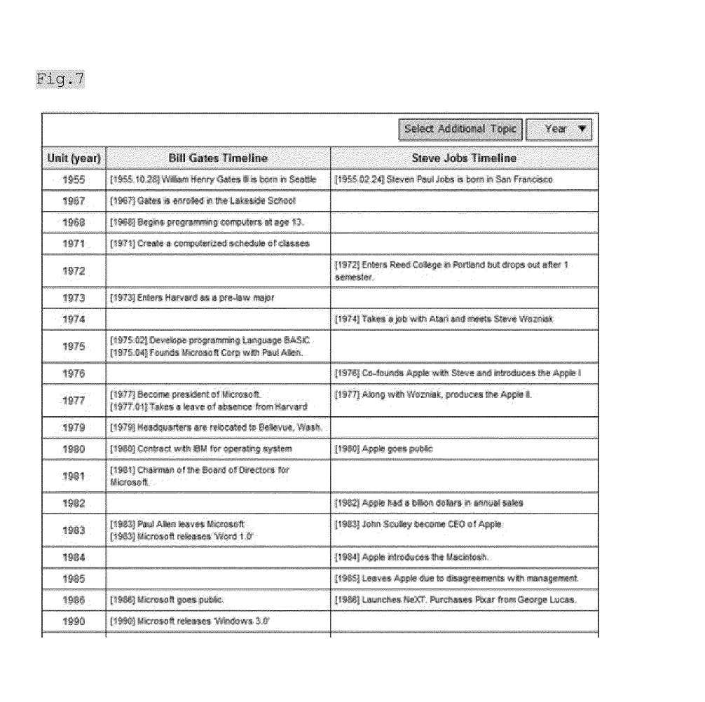

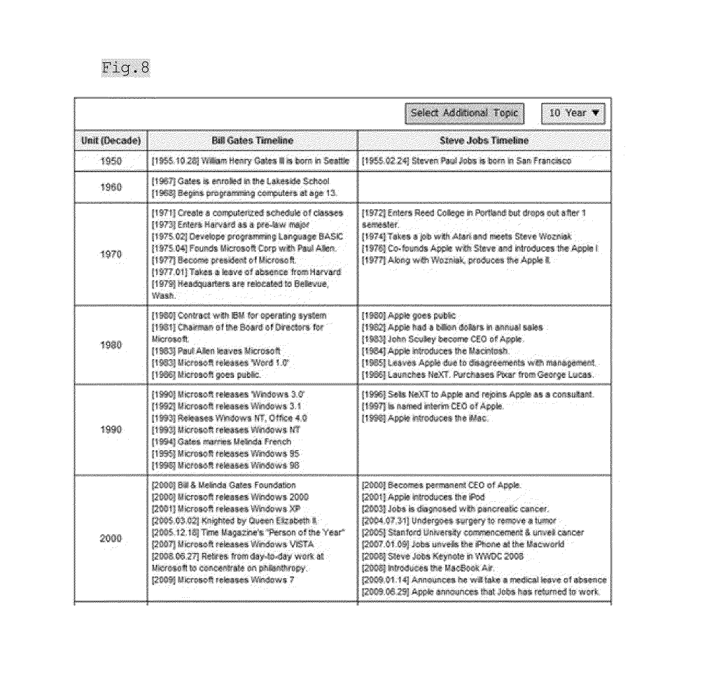

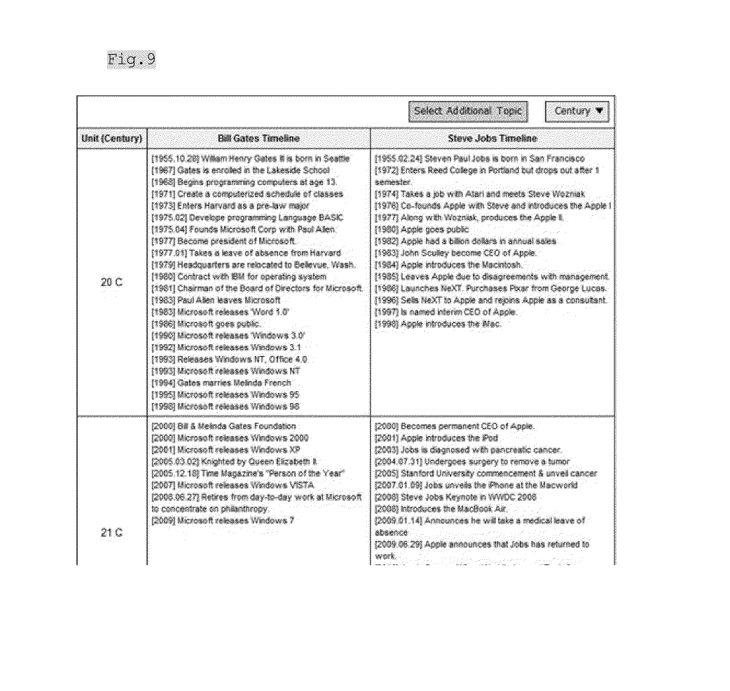

FIG. 1 is a block diagram showing an active chronicle comparison system using websites according to an embodiment of the present invention. FIG. 2 is a flowchart showing the operation sequence of the active chronicle comparison system using websites, shown in FIG. 1. FIG. 3 is a diagram showing a screen in which the elements of principal fields of a topic table constructing a DB and an event table for storing events for respective topics, and in which sample data is input and illustrated. FIG. 4 is a diagram showing an image of a state in which ‘United States (US) history’ is selected from the topic table of FIG. 3 and chronological table data is displayed on the screen. FIG. 5 is a diagram showing an image of a state in which chronological table data corresponding to ‘French history’ is added to the screen shown in FIG. 4, and a comparative screen is formed. FIG. 6 is a diagram showing an image of a state in which a chronological table corresponding to ‘Korean History’ is added to the screen shown in FIG. 5. FIG. 7 is a diagram showing a screen in which a field is changed, and two topics of respective personalities named ‘Bill Gates’ and ‘Steve Jobs’ are compared with each other and in which chronological table data corresponding to the topics is displayed. FIG. 8 is a diagram showing an image of a state in which the unit of a comparing period sector of chronological table data in the screen shown in FIG. 7 is set to 10 years (decade). FIG. 9 is a diagram showing an image of a state in which the unit of the comparing period sector of the chronological table data in the screen shown in FIG. 7 is set to 100 years (century).

As shown in FIGS. 1 to 9, an active chronicle comparison system using websites according to an embodiment of the present invention includes a database (DB) unit 10, an engine unit 20, and a user terminal 30.

The DB unit 10 is a device for arranging and storing occurrence times (dates) of events that occurred for respective topics and the contents of the events into a DB. Here, any topics and events may be used as the topics and events stored in the DB unit 10 as long as they include year as in the case of history, people, philosophy, art, learning, technology, sports, products, and company history. That is, the DB unit 10 provides a DB related to topics in various fields, as well as history, thus providing the comparison of various combinations.

The engine unit 20 is operated in conjunction with the DB unit 10, and includes a chronological table generation unit 21 for generating chronological table data from dates and events for a topic requested by the user and for generating a single comparative chronological table for multiple topics when multiple topics are selected, and a comparing period sector setting unit 22 for restructuring chronological tables via the comparing period sector setting unit 22 when the user changes the unit of a comparing period sector (1 year, 10 years, 100 years, 1000 years, 10000 years, a million years, or a hundred million years).

The user terminal 30 is a device that is operated in conjunction with the engine unit 20, and that is configured to request events for respective topics from the engine unit 20, display the chronological table data generated by the engine unit 20, and request an additional comparative topic and an additional comparing period sector from the engine unit 20. Such a user terminal 30 may be implemented as a computer device enabling Internet communication.

Below, the operation of the active chronicle comparison system using websites according to an embodiment of the present invention will be described.

First, when ‘US history’ is selected from the results of searching the DB 10 on the user terminal 30, as shown in FIG. 3, the engine unit 20 displays chronological table data related to US history on the screen of the user terminal 30, as shown in FIG. 4.

In this case, the user terminal 30 may search and select an additional topic in addition to the selected topic, and add the additional topic to be compared with US history that is a current topic. For example, when a topic for French history is added by selecting a button [Select Additional Topic] on the user terminal 30, the engine unit 20 combines chronological table data matching US history with chronological table data matching French history to generate combined data, and then displays comparative chronological table data matching both US history and French history on a single screen, as shown in FIG. 5.

Furthermore, in this state, a further topic may be added by using again the button [Select Additional Topic] on the user terminal 30. For example, when a topic for ‘Korean history’ is added via the user terminal 30, the engine unit 20 combines three chronological tables matching ‘US history,’ French history,′ and ‘Korean history’ to generate comparative chronological table data in which the three chronological tables are classified by year, and then displays the comparative chronological table data on the screen in the form of a single table, as shown in FIG. 6.

Further, the user terminal 30 may compare various topics as well as history. For example, when topics for personalities named ‘Bill Gates’ and ‘Steve Jobs’ are sequentially selected via the user terminal 30, the engine unit 20 generates two pieces of comparative chronological table data matching ‘Bill Gates’ and ‘Steve Jobs,’ and comparatively displays them on a single screen, as shown in FIG. 7. Of course, it is also possible to compare history with people, and in addition, to variously combine and compare all topics stored in the DB 10.

That is, when receiving a request for inquiry about events for two or more topics from the user terminal 30, the engine unit 20 generates pieces of chronological table data matching the requested two or more topics so that they are output via a single screen, and then displays the generated chronological table data on the user terminal 30.

As described above, the active chronicle comparison system using websites according to the embodiment of the present invention constructs a DB by arranging history into chronological tables, and displays the chronological tables on a single screen in units of a comparing period sector so that individual chronological tables may be compared in various manners, thus enabling histories in different fields to be compared and understood at a glance. Therefore, it may be considered that the active chronicle comparison system using websites according to the embodiment of the present invention may be regarded as exhibiting peculiar effects that are unpredictable in a conventional prior document that displays only a single chronological table, from the standpoint of the fact that histories in different fields can be compared.

Meanwhile, the engine unit 20 may include the chronological table generation unit 21 and the comparing period sector setting unit 22.

The chronological table generation unit 21 searches the DB unit 10 for events stored in the DB unit, and displays chronological table data.

The comparing period sector setting unit 22 sets a period sector so that event data is restructured and displayed in units of a specific comparing period sector depending on date data stored in the chronological table generation unit 21.

The operation of the engine unit 20 including the chronological table generation unit 21 and the comparing period sector setting unit 22 will be described in detail below. As shown in FIG. 7, when personal chronicles of personalities named ‘Bill Gates’ and ‘Steve Jobs’ are compared with each other, the engine unit 20 assigns authority to set the comparing period sector to the user terminal 30. FIG. 7 shows a state in which historical events of Bill Gates and Steve Jobs are displayed by year (initial period), that is, for respective years, as they are stored in the DB.

In this case, the user terminal 30 may set the unit of the comparing period sector via the comparing period sector setting unit 22. For example, when the comparing period sector is set to 10 years (decade), as shown in FIG. 8, the comparing period sector setting unit 22 restructures events displayed in respective pieces of chronological table data in units of decade that is the comparing period sector requested by the user terminal 30, and displays the restructured event data on the user terminal 30.

Unlike this, when the user terminal 30 sets the unit of the comparing period sector to 100 years (century), as shown in FIG. 9, the comparing period sector setting unit 22 restructures events displayed in respective pieces of chronological table data matching Bill Gates and Steve Jobs in units of 100 years that is the comparing period sector requested by the user terminal 30, and displays the restructured events on the user terminal 30.

In this way, when event data is divided into specific period sectors according to the date data by the comparing period sector setting unit 22, the comparing period sector may be set to a value corresponding to any one of 1 year, 10 years (decade), 100 years (century), 1000 years, 10000 years, a million years, and a hundred million years, and then the chronological table data may be provided in units of a period sector requested by the user terminal 30.

As described above, the active chronicle comparison system using websites according to the present invention arranges historical events for respective comparing period sectors such as 10 years and 100 years, upon comparing chronological tables having different topics, classifies the events that have occurred by the corresponding comparing period sector, and displays the classified events on the screen, thus allowing the chronological tables to be edited according to the user's necessity and maximizing the utilization of the tables as comparative data and editing data.

Meanwhile, as shown in FIGS. 3 to 9, when respective pieces of chronological table data for comparison are generated by the engine unit 20, and are displayed on the user terminal 30, the engine unit 20 generates Uniform Resource Locator (URL) addresses having information about topics and comparing period sectors constituting the chronological table data, and transmits the URL address of the corresponding chronological table data together with the chronological table data to the user terminal 30. Here, the URL address transmitted to the user terminal 30 is implemented such that a unique address is given to each piece of chronological table data, the URL address containing comparing period sector information.

In this case, in a state in which the URL address of a comparative chronological table edited as comparative data by the user terminal 30 is stored, when the user terminal 30 re-accesses the URL address, the unique comparative chronological table may be displayed on the corresponding URL address. By applying this, the user terminal 30 may transfer the corresponding URL address to other users, thus allowing the unique comparative chronological table viewed by the user to be viewed by the other users without change.

In this way, the active chronicle comparison system using websites according to the present invention generates and transfers a unique URL address associated with chronological table data upon generating the chronological table data, and is then capable of very easily holding or transferring a generated comparative chronological table without separately storing the comparative chronological table.

1. An active chronicle comparison system using websites, comprising:
a database (DB) unit for arranging and storing occurrence dates and contents of events that occurred for respective topics into a DB;
an engine unit for operating in conjunction with the DB unit, and generating chronological table data using the contents and the occurrence dates of the events in the DB unit, upon receiving a request for inquiry of events; and
a user terminal for operating in conjunction with the engine unit, and displaying the chronological table data generated by the engine unit,
wherein the engine unit is configured to, when a request for inquiry of events for two or more topics is received from the user terminal, generate a comparative chronological table so that pieces of chronological table data matching the requested two or more topics are compared with each other on a single screen, and display the comparative chronological table on the user terminal.

2. The active chronicle comparison system of claim 1, wherein the engine unit comprises:
a chronological table generation unit for searching the DB for events stored in the DB, and outputting the chronological table data; and
a comparing period sector setting unit for setting a period sector so that the comparative chronological table generated by the chronological table generation unit is displayed in units of a specific period sector,
when the user terminal sets a unit of a comparing period sector via the comparing period sector setting unit, the chronological table generation unit restructures events displayed in the comparative chronological table in units of a comparing period sector requested by the user terminal, and displays the restructured events on the user terminal.

3. The active chronicle comparison system of claim 2, wherein when the comparing period sector setting unit classifies the comparative chronological table in units of a specific period sector, the comparing period sector is set to a value corresponding to any one of 1 year, 10 years, 100 years, 1000 years, 10000 years, a million years, and a hundred million years.

4. The active chronicle comparison system of claim 1, wherein when the user terminal requests the chronological table data via the engine unit, the engine unit generates a Uniform Resource Locator (URL) address including information about a comparison topic and a comparing period sector constituting the comparative chronological table, and transmits the URL address of the chronological table data to the user terminal.
